(19) United States
(12) Patent Application Publication
(10) Pub. No.: US 2016/0358252 A1
(43) Pub. Date: Dec. 8, 2016

(54) Commodity Matching, Allocation, and Delivery

(71) Applicant: MASS METAL L.L.C., Lawrence, KS (US)

(72) Inventors: Jeremy Dennis Brakenhoff, Lawrence, KS (US); Timothy Mark Gallagher, Lawrence, KS (US)

(73) Assignee: MASS METAL L.L.C., Lawrence, KS (US)

(21) Appl. No.: 14/729,461

(22) Filed: Jun. 3, 2015

(51) Int. Cl. G06Q 40/04

(52) U.S. Cl. CPC G06Q 40/04

(57) ABSTRACT

Potential buyers of commodities and potential sellers of commodities may be matched using a variety of criteria. By validating the commodities available for sale or other transaction and by verifying a potential purchaser of commodities, the traditional overhead associated in commodity transactions can be substantially reduced, thereby making the underlying commodities more favorable investment options or production inputs for participants. At least one computer, such as one or more server, implementing methods in accordance with the present invention may communicate with a plurality of participant computing devices to coordinate the buying, selling, delivery, retention, payments, and other transactions related to the buying, selling, and/or exchange of commodities. Commodities such as, but not limited to, metals, grains, and other substantially fungible materials may be bought, sold, and/or exchanged.

### CROSS-REFERENCE TO RELATED APPLICATIONS

This application claims the benefit of provisional patent application Ser. No. 62/007,662, entitled “Commodity Matching, Allocation, and Delivery,” filed on Jun. 4, 2014, which is incorporated herein by reference.

### FIELD OF INVENTION

The present invention relates to the management of commodities. More particularly, the present invention relates to the selling/buying of commodities based upon criteria such as type, price, geographical location, and delivery options.

### BACKGROUND AND DESCRIPTION OF THE RELATED ART

A variety of commodities are used as the basis of modern finance, as well as inputs to the production of many commercial products. Access to commodity markets, and the resulting ability to buy, sell, or otherwise trade and deal in a particular commodity or commodities, may be required to obtain the inputs needed to produce commercial products. For example, commercial bakeries are able to obtain wheat for use in their operations via commodity transactions.

In addition to providing inputs for use in producing commercial products, commodity markets provide opportunities for hedging risks and/or investing for potential economic gain. Commodities such as agricultural products, metals, and other fungible or non-fungible goods are amenable to trading, either in the physical material itself or in options or derivatives or other rights or obligations related to the physical commodity. As a result, in addition to those engaged in commercial production related to commodities, investors may participate in commodity markets for direct economic gain.

While some investors have been able to advantageously invest in commodities, most commodity investments are available only by incurring often substantial transaction costs. For example, an individual may wish to purchase a precious metal, but may only be able to do so directly in the form of coins or jewelry from a retailer charging a markup over the spot price for the metal or indirectly through a mutual fund or other investment vehicle charging management fees. By way of further example, a small artisanal bakery may wish to buy wheat to produce fresh flour for use in baked goods, but will likely have to pay a substantial premium over the price of wheat quoted on commodity markets due to the relatively small amount of wheat purchased, and yet have to arrange delivery of the wheat purchased. These high transaction costs undercut the investment advantages of commodity trading and increase costs to consumers and limit the ability of all but the largest businesses to use commodities as an input. In some instances the transaction costs associated with buying and selling commodities may place individuals or small organizations/institutions at a competitive disadvantage in investment markets. This competitive disadvantage may exist whether the purpose of a transaction is to use the commodity involved as an input to some other production process (such as is the case in the example of an artisanal bakery) or as an investment vehicle (such as is the case in the example of an individual wishing to buy precious metal). Further, the impediments of transaction costs typically for sellers as well as buyers of commodities or any other participant in a commodities-based transaction. While the transaction costs and the source of those transaction costs may vary for different types of commodities, the transaction costs associated with buying and selling commodities inherently create a drag on commercial of and/or investment in commodities.

### SUMMARY OF THE INVENTION

Systems and methods in accordance with the present invention enable individuals and/or a wide variety of organizations/institutions to participate in commodity markets while avoiding or reducing the large transaction costs otherwise associated with those commodity transactions. Inventories of one or more type of commodity may be verified prior to being made available for purchase. The verified inventories may be retained in a suitable storage facility such as a depository or other storage location. Records of the type, amount, offered sale price, geographical location, delivery/retention options or other relevant information describing the verified commodity may be created or retained. A potential purchaser of a commodity may search for commodities based upon commodity type, price, geographical location, delivery/retention options, or other properties. Commodities may enter the system from authorized producers or other entry processes.

Systems and methods in accordance with the present invention may be implemented using database records and computer executable instructions retained in a non-transitory machine-readable medium or media. The machine-readable medium/media retaining the computer executable instructions and/or database records may be distributed over a number of computers or other devices that communicate over a network, such as the Internet or a similar private network. Any type of network protocol(s) may be used for such communication and to provide a desired level of security for those communications. The computer executable instructions may cause one or more computing device to enable a potential seller of a commodity to provide information regarding a commodity available for purchase, for a potential buyer of a commodity specify the criteria of a potential purchase of a commodity, to match one or more prospective buyer of a commodity with one or more prospective seller of a commodity, to optimize a potential multiplicity of transactions involving commodities for purposes of efficiency or security, to validate one or more participants to a transaction, to validate a particular transaction, arrangement for the retention/delivery of a commodity, and/or other aspects of a transaction (such as payment receipt/disbursement and/or any required governmental reporting).

Systems and methods in accordance with the present invention permit participants to engage in buying, selling, and/or exchanging of commodities and to maintain ownership of commodities without barriers to their participation such as the size of their transactions, the amount of their holdings, or their physical location. By providing a seamless integration between participants and storage facilities, participants obtain the ability to control the allocation of the commodities they own. A desired allocation of commodities may be considered in terms of the geographical location of the commodities, the particular type of commodities, and/or the physical form of those commodities. For example, a participant may take advantage of arbitrage opportunities presented between commodities with different types, forms or locations. One example of such an arbitrage opportunity may occur if the price for gold coins places a substantial premium on coins relative to bullion, as an owner of coins within the system could exchange those coins for bullion without excessive transaction costs, even if only a small number of coins were to be exchanged for a fractional ownership of a larger bar. The ability to conduct such a transaction without requiring a physical delivery of the materials involved or the premiums or other barriers to entry of the traditional commodities markets may provide investment opportunities for participants and ultimately more efficient pricing for the commodities involved.

While described herein in conjunction with specific examples, the present invention may be implemented for any type of transaction involved with any kind of commodity. The present invention is not limited to any particular computing architecture, software choice, or IT implementation. Further examples of systems and methods in accordance with the present invention are described below.

### BRIEF DESCRIPTION OF THE SEVERAL VIEWS OF THE DRAWINGS

Examples of systems and methods in accordance with the present invention are described in conjunction with the attached drawings, wherein:

FIG. 1 schematically illustrates exemplary criteria used in accordance with the present invention to match buyers and sellers of commodities;

FIG. 2 schematically illustrate an example of a system in accordance with the present invention;

FIG. 3 schematically illustrates a further example of a system in accordance with the present invention; and

FIG. 4 schematically illustrates a system for buying and/or selling commodities in accordance with the present invention.

### DETAILED DESCRIPTION

Systems and methods in accordance with the present invention permit buyers and sellers of commodities to be appropriately matched with one another. In accordance with the present invention, criteria used in matching buyers and sellers of commodities may be information such as a commodity type, a commodity location, a commodity price, and/or a commodity delivery or retention plan may be a criteria used in matching sellers and buyers of commodities. Systems and methods in accordance with the present invention may additionally/alternatively be used to facilitate trades or other exchanges of commodities between two or more participants.

For example, a buyer may wish to purchase a particular type or types of one or more commodity, such as metals, grains, or other resources. A potential purchaser may have varying degrees of specificity in terms of the commodity or commodities to be purchased. For example, a purchaser may merely want to purchase precious metals in general, or may prefer a particular type of metal such as gold, or may even prefer a particular type of gold coin or bullion, or may have other varyingly specific preferences for purchasing types of available commodities. Similarly, a purchaser may have price constraints or expectations in a potential purchase of commodities. For example, a purchaser may be unwilling to pay more than a specified amount for an ounce of metal, a bushel of grain, etc. Further, a potential purchaser of commodities may prefer to purchase commodities at one or more geographical locations. For example, a potential purchaser of commodities may prefer to purchase material physically proximate to the purchaser, to thereby provide convenient delivery or pickup of the purchased commodity. On the other hand, a potential purchaser of commodities may prefer to not take delivery of the purchased commodity, but rather may prefer to utilize a commodity storage facility such as a depository or other storage service to retain the commodity until such a time that delivery is desired or that the commodity is to be sold to a subsequent purchaser. Particularly in instances where a potential purchaser of commodities prefers not to take physical delivery of the purchase commodity, the purchaser may desire a geographical distribution of the acquired commodities, for example so as to own commodities in depositories or other storage services in a distributed fashion to avoid localized risks. Fractional ownership of a commodity may be particularly helpful to permit a desired level of geographical distribution to owned commodities, access for potential purchasers, and/or partial liquidation of a commodity item by a seller. For example, a bar of gold may comprise four hundred ounces in total, but multiple entities may own fractional portions of the bar, thereby permitting purchaser to gain ownership in a bar of gold without having to acquire discrete four hundred ounce increments of gold. Of course, in some instances different criteria may be more or less important to a particular individual potential purchaser of commodities. The systems and methods in accordance with the present invention may account for the different levels of importance placed upon different criteria in the purchasing of commodities in order to provide an optimal match of a seller to a buyer of one or more commodities. Moreover, systems and methods in accordance with the present invention may be used to permit an individual purchaser to obtain commodities from a multitude of sellers in a fashion that meets the purchasers at desires, but that might not have been attainable from a single seller or other source of the commodities.

In addition to providing opportunities for purchasers of commodities to obtain desired commodities in a fashion that meets the purchaser's needs, systems and methods in accordance with the present invention provide opportunities for sellers of commodities to offer their materials for sale into a liquid market that enables potential purchasers to buy commodities in a fashion that is convenient to both the buyer and the seller with a minimum of overhead. In this fashion, both an owner of commodities seeking immediate or future sale of those commodities and a potential purchaser of those commodities benefit from use of the systems and methods in accordance with the present invention.

By validating the sellers of commodities and the commodities available for purchase, systems and methods in accordance with the present invention may substantially eliminate the risk of the failure to deliver a purchase commodity or that a purchased commodity may have been misrepresented. Further, by validating potential purchasers of commodities, sellers of commodities can avoid the risk of nonpayment from buyers of their commodities. By maintaining affiliated depositories or other storage facilities holding commodities available for purchase, systems and methods in accordance with the present invention may permit an efficient electronic trading of commodities to occur, with any particular trade or trades of commodities being selected by any of a number of criteria potentially beyond, but including, the type and price of the subject commodity. For example, a purchaser may select between otherwise fungible commodity purchases by selecting those with a preferred delivery, retention, or distribution policy or arrangement.

Systems and methods in accordance with the present invention permit the buying and selling of commodities while avoiding the overhead and transaction costs typically associated with such transactions. For example, in a typical transaction involving a precious metal coin that does not utilize the present invention, a seller will typically have to sell her coin to a dealer at substantially below the market rate for that metal quoted from various publicly traded commodity exchanges, and then a subsequent purchaser of that coin will pay an amount exceeding the market rate for that metal quoted from various publicly traded commodity exchanges. The margins below the quoted exchange rate (for the initial seller of the coin) and above the quoted exchange rate (for the eventual purchaser of the coin) cover the overhead and profit of the dealers involved and other middlemen to the transaction. While the one or more dealers involved with such a transaction between a seller of a precious metal coin and a buyer of the precious metal coin may provide valuable knowledge and validation of the authenticity of the commodity involved, the typically very high margins of a dealer purchasing from a seller and then the same or a different dealer selling to a buyer may typically render an investment in such a coin problematic for the purchaser, as the coin must increase considerably in value after purchase in order to cover the transaction costs involved in the initial purchase and then subsequent sale in order to liquidate that commodity at a break-even price, much less at a profit. In accordance with the present invention, the overhead associated with specialized dealers may be reduced or entirely eliminated by validating commodities when they enter a certified depository or other storage location and by providing validation of both purchasers and sellers of commodities.

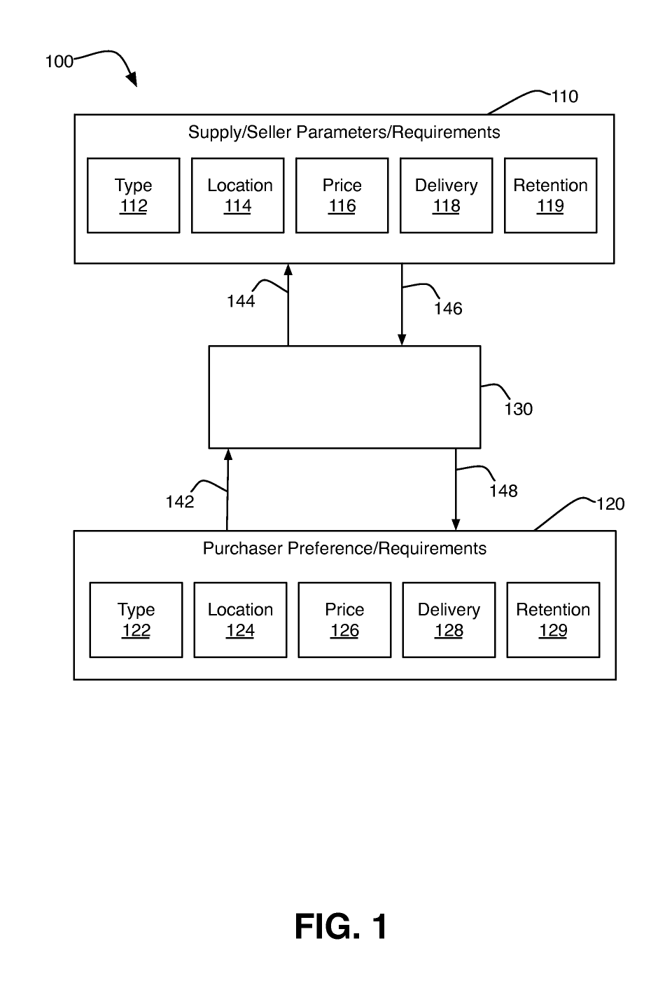

Referring now to FIG. 1, an example of a system 100 in accordance with the present invention is illustrated. System 100 may match the commodities available for sale from sellers with the purchasing preferences of buyers. Commodities within a known supply may be listed for sale by the current owner of those commodities. The current owner may offer those commodities for sale based upon one or more seller parameter(s) or requirement(s) 110. One example of a seller parameter is a commodity type 112. A commodity type 112 may be specified with varying degrees of precision in accordance with the present invention, and commodity type 112 may comprise various types, subtypes, or other classifications of commodities. For example, a commodity type 112 could define a particular commodity at a high level, such as “precious metal” or “grain” with a subtype where further classification may be used to more particularly describe a commodity. Further, a commodity may be described at many levels of detail as its commodity type 112. For example, a commodity type 112 may be a “grain” of a subtype “wheat” and a further subtype of “hard winter wheat.” Similarly, an example commodity may be a “precious metal” of a subtype “gold” and a subtype “gold coin” and a yet further subtype of “American Gold Eagle.” A potential seller of a commodity may optionally be required in accordance with the present invention to fully describe the type and various subtypes of a commodity, while a potential purchaser of a commodity may not desire to search for an available commodity at a particularly fine degree of precision for subtypes in some implementations of the present invention. Any number and variety of types and subtypes of commodities may be used in accordance with the present invention.

Still referring to FIG. 1, a commodity location 114 may also comprise one of the parameters 110 of a commodity available for purchase from a seller. The commodity location 114 may be, for example, identified as a particular depository at a particular geographical location. The geographical location 114 may be valuable information to a potential purchaser of a commodity seeking, for example, to obtain a commodity portfolio with an adequate geographical distribution to distribute risk of physical damage, theft or other physical loss in a desired fashion geographically. Additionally, a commodity location 114 may be useful for a potential purchaser to acquire commodities conveniently located for pickup or delivery.

Commodity price 116 may reflect the price at which a commodity owner is willing to sell a given unit of a particular commodity. Commodity price 116 may be denoted in any currency unit, but may additionally or alternatively be denoted in terms of a different commodity type if a commodity exchange is desired or acceptable to the commodity owner.

Commodity delivery 118 may also be a parameter/requirement 110 defined by a potential seller of a commodity. For example, in some instances a commodity may be available for delivery within a particular time frame, at a particular level of insurance, and/or at a particular cost. A commodity retention 119 option may comprise the terms by which a commodity may be held or otherwise maintained on behalf of a purchaser, whether by the seller of the commodity or another party, such as a commodity retention service like a depository or other facility. A commodity retention 119 option may require a periodic payment of a fee to a commodity retention service such as a depository or other storage entity.

Purchaser preferences/requirements 120 may vary along the same types of criteria as the supply or seller parameters/requirements 110. For example, a potential purchaser of a commodity may specify a commodity type 122 with varying levels of detail or specificity, such as described above with regard to seller commodity type 112. Similarly, a purchaser's preference for a commodity location 124 may be matched against a seller's commodity location 114. Further, a purchaser's commodity price preference 126 may be matched to a seller's commodity price 116. A purchaser's commodity delivery preference 128 may be matched with a potential seller's commodity delivery options 118. A purchaser's commodity retention 129 preference may similarly be matched with the commodity retention 119 options offered in conjunction with the sale of a commodity, whether offered by the seller or a commodity retention service.

The matching of purchaser preferences 120 with seller preferences 110 may be performed by a matching engine 130. Matching engine 130 may comprise or access a variety of databases or other electronic records indicating details such as seller preferences 110 for all or part of the commodities in a supply. Matching engine 130 may be implemented as computer software retained in one or more non-transitory machine-readable medium that causes a computing device or multiple computing devices to execute steps of operations in accordance with the present invention. Matching engine 130 may receive 146 seller parameters 110 and provide 148 a potential purchaser only those commodities available for purchase that match all purchaser preferences/requirements 120 received 142, or may show commodities available for purchase that match some but not all of the purchaser's preferences/requirements 120. Matching engine 130 may also provide 144 a seller information regarding entirely or partially matching purchaser preferences 120, As commodities may be fungible, matching engine 130 may only indicate that commodities matching the purchaser preferences/requirements 120 are available for acquisition, although in some examples variations of a parameter not specified by the potential purchaser (such as, for example, geographical location within a single country or city) that differ within a group of commodities that all meet the purchaser preferences/requirements 120 may be presented to a potential purchaser for consideration.

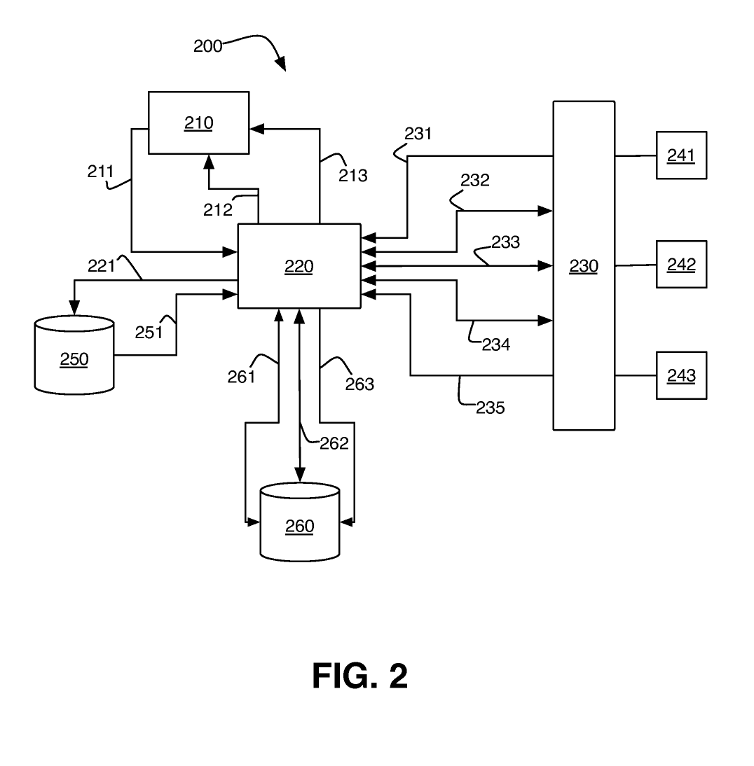

Referring now to FIG. 2, a schematic diagram further illustrating an example of a system 200 in accordance with the present invention is provided. At least one computing device 220 may operate to execute software implementing methods in accordance with the present invention and to access records and databases as required in accordance with the present invention. At least one computing device 220 may be one or more server, for example accessed over a network, but may also comprise one or a plurality of computers operating in a peer-to-peer system or other appropriate distributed arrangement, which may require security techniques such as encryption. While the at least one computing device 220 may be referred to as at least one server herein, systems and methods in accordance with the present invention may be implemented in a variety of computing environments beyond a conventional server arrangement. Various client computers 230 may be operated by participants and used to access the at least one server 220 to engage in transactions buying or selling commodities or related to the buying and selling of commodities, such as providing/receiving funds, reviewing transaction histories, searching for potential sellers/buyers, etc. Participants may access the at least one server 220 via a network connection, that may benefit from various types of security and/or encryption techniques. Network connections between client computers may be over the Internet, one or more intranets, a virtual private network, a direct connection, etc., and may use any communication protocol for the exchange of information between the client computers and the at least one server 220. The client computers 230 may comprise personal computers, mobile devices, tablet computers, mobile phones, set top boxes, or any other type of computing device. Client computers 230 used by participants to access the at least one server 220 may execute software, whether specially created for that purpose or a general purpose Internet browser or a combination thereof (such as a general purpose browser with a specially created plug-in) to exchange information with the at least one server 220 over a network connection with a desired level of security and/or encryption.

The software operating on the at least one server 220 and within various client devices 230 may operate in accordance with various application protocol interfaces, often referred to as APIs. For example, a client 230 may make a buy or sell request 231. The same or a different client 230 may request 232 a transaction history. The same or a different client 230 may make a login request 233, which may be the first operation performed between a client device 230 and the at least one server 220 in order to permit the user of the client device 230 to perform additional operations. Still referring to the example of FIG. 2, the same or a further client 230 may make a balance request 234 to the at least one server 220. A balance request 220 may return from the at least one server 220 more than one quantity, for example a value of currency on deposit with system 200 and the discrete amounts of various commodity types owned by a user within the system 200. A further API may be provided for a client 230 operated by a potential participant to enroll 235 with the system 200. The process to enroll 235 may involve validating the identity of a potential participant, the availability of funds or other resources (such as commodities for sale), the collection of information required by taxing authorities or regulatory agencies, etc. The process to enroll 235 with system 200 may require multiple steps, some of which may be performed using software and/or some of which may be performed physically (for example, to verify the identity, amount, and/or purity of a commodity brought into system 200).

Still referring to FIG. 2, a client 230 participating in system 200 may further comprise an individual, a business, an investment entity, dealers in one or more type of commodity, a commodity storage facility such as a depository, granary, silo or other storage entity that provides retention services for purchased commodities and may, in some circumstances, be any other entity that may desire to participate as a buyer and/or seller of commodities using the system 200. Further, optionally system 200 may permit a client 230 to support, create, or otherwise authorize sub-clients, such as a first sub-client 241, a second sub-client 242, and a third sub-client 243. A sub-client (such as first 241, second 242, and/or third 243 sub-client) may possess all or parts of the rights and/or access to system 200 as a typical client 230, and in some examples a client 230 may bear varying degrees of responsibility for transactions involving a sub-client.

Still referring to FIG. 2, a participant database 260 may provide an electronic record of registered participants of system 200. The at least one server 220 may access participant database 260 for functions such as authentication requests 262, participant lookup 261, participant additions 263, or for other transactions. Participant database 260 may comprise multiple databases and may be formed using any appropriate database technology, structure, format, etc. Further, a transaction history database 250 may provide or perform transaction history recording operations in conjunction with the at least one server 220 of system 200. The at least one server 220 may store 221 transaction details in the transaction history database 250. The at least one server 220 may periodically retrieve 251 transaction history details from the transaction history database 250 as required to administer the system 200 and/or as requested by participants.

Still referring to FIG. 2, at any given point in time the system 200 may have any appropriate order matching software 210. The order matching software 210 may operate on the at least one server 220 or elsewhere. The at least one server 220, may initiate 212 an order in the order matching software 210 involving the matching of the preferences/requirements of potential sellers and potential buyers of commodities. As a transaction will involve at least one, and potentially many, participants with records retained within the one or more participant database 260, the at least one server 220 may access wallet details 213 as part of any match made by matching software 210. Wallet details 213 may describe, for example, the commodities verified as available for a participant to sell or trade, the funds available in a currency for use by a participant, the commodities subject to a transaction, the currency amounts subject to a transaction, and the like. Ultimately, a match may be made by matching software 210, permitting a transaction to settle 211.

One or more of a variety of software types may be used as matching software 210. Matching software 210 may comprise a commercially available software product, a specially developed software product, a combination of software, etc. Further, matching software 210 may operate on a single computing device or may be spread over several computing devices.

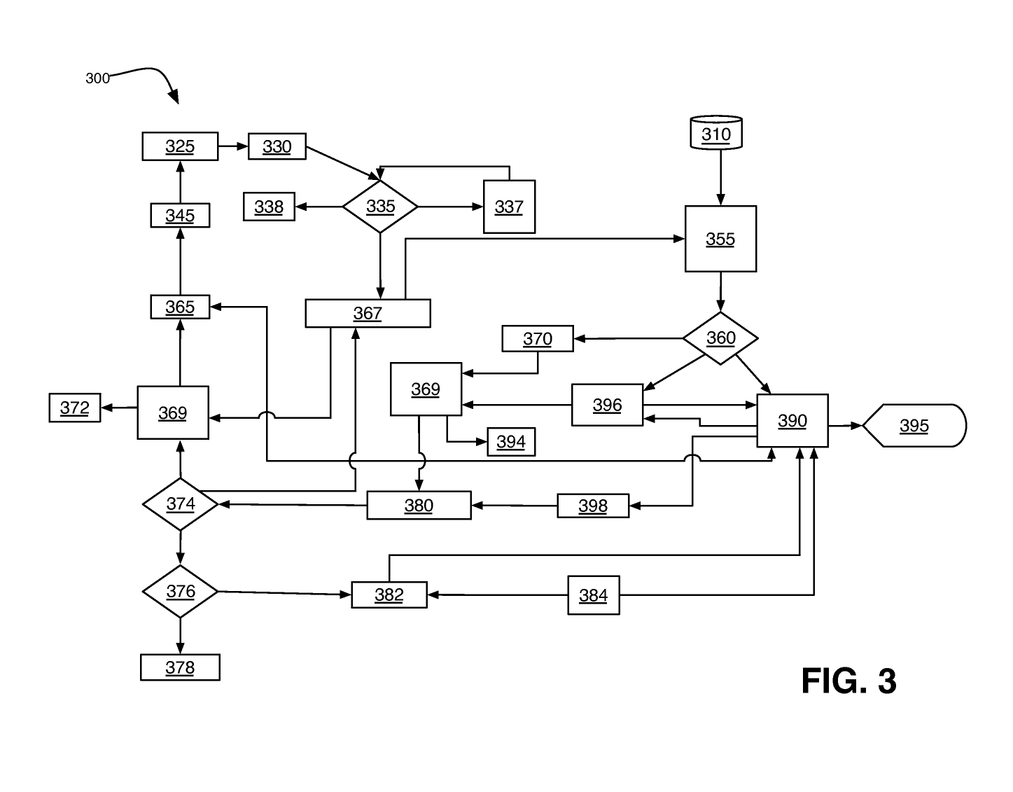

Referring now to FIG. 3, a further schematic illustrates an example of a system 300 in accordance with the present invention. System 300 may be implemented using at least one server in communication with one or more client devices, using a distributed system, or in any other computing environment. System 300 may provide multiple access points for individuals wishing to buy or sell commodities using the system 300. For example, a member of the public or other entities may access the system 300 by becoming a registered participant 310, which may require providing and verifying details regarding the identity of the potential participant and financial details regarding the potential participant. A potential participant may be an individual or other entity, such as a trust, a company, an investment club, small business, partnership, or other legal entity. Further, participant may be a dealer in one or more type of commodity available for purchase or sale via system 300. Similarly, a commodity storage facility, such as a depository providing services in retaining or ultimately delivering a commodity, may similarly become a participant 310 in system 300. Different types of participants 310 may be permitted, with different types of actions permitted by different types of participants 310. For example, some participants 310 may be depositories 320 optionally may only provide retention services for commodities bought, sold or exchanged using system 300 without themselves engaging in buying, selling or trading of commodities within system 300. Further, some participants may enroll with system 300 as a member of another participant, such as when a participant 310 that is a storage facility makes available to its clients the ability to participate in commodity transactions using system 300, potentially as sub-clients.

Still referring to FIG. 3, a participant may elect to initiate a transaction 355 via system 300. Examples of potential transactions 355 are a request for a quote regarding one or more commodity, for example to buy, sell, deliver, store, locate, and/or exchange a commodity. An order type determination 360 may be required based upon the type of transaction 355 requested by a participant.

In the event of a sell order 370, system 300 may access an availability module 369 to determine whether the commodity to be sold is available for that user to sell. The availability module 369 may notify 394 a user of this determination. If the availability module 369 determines that the commodity is available for sale, system 300 may use an order match component 380 to match the commodities desired to be sold with a potential buyer, with such a potential buyer and the associated purchase request being processed, for example, as described herein. The outcome of processing by an availability module 369 may be output 394 to a user to advise a user as to the availability of a commodity to be sold, the result of the sale of the commodity on the potential seller's account, etc.

If the order type 360 comprises an exchange 396, the availability module 369 may be engaged to determine whether the commodities to be exchanged are available for the participant desiring to initiate the exchange 396. If availability module 369 determines that the commodity is available, system 300 may proceed to execute an order match 380. The outcome of the availability module 369 operation may be provided in a user notification 394.

If order type 360 comprises a purchase requiring a payment module 390, payment module 390 may determine whether funds are available for the desired transaction and, if the required funds are either not available, have not yet cleared in the relevant trading account, or if notification of the potential purchaser of other parameters (such as remaining funds available after a purchase is made), the participant may the appropriately notified 395. If payment module 390 determines the required funds are available in an acceptable fashion, the exchange order module 396 may be engaged as described above to determine the availability of a desired commodity in the availability module 369 and via an order matching module 380. Further, payment module 390 alternatively may additionally/alternatively create a buy order 398 using available funds or other resources, at which point system 300 may proceed directly to an order match execution 380.

Once an order match 380 has been made, one or more buy or sell transactions 374 may require execution. As a result of the one or more buy or sell transactions 374, a variety of further actions may be required, although some transactions may not require all of these further actions.

For example, a buy or sell transaction 374 may require the withdrawal or retention of funds 376. In some instances, the withdrawal of funds 376 may require funds to be sent 378, for example to provide the proceeds of a sale to a seller. In other instances, the withdrawal or retention of funds 376 may result in funds being retained in a trust account 382, for example in order for those funds to be available for further transactions by a participant within system 300. The funds available in a trust account 382 may be available for subsequent transactions using a payment module 390. Further, confirmed payment methods 384 may interact with the trust account 382, although any other type of funds transfer, credit transaction, or other process may be implemented within the scope of the present invention.

The result of a buy or sell transaction 374 may require accessing a further availability module 369 and the notification 372 of a user as to the outcome and determination of availability module 369. In some instances, a determination of an availability module may require a shipping payment 365 in order for a purchased commodity to be transmitted as requested by a purchaser. After a shipping payment 365 has been received, the purchased commodity may be in transit 345 until ultimately the commodity is in the possession of a customer 325. A customer in possession 325 of a commodity, whether the commodity is obtained via system 300 or through other means, may wish to introduce the commodity into the system 300 in order to permit subsequent transactions involving that commodity, and may thereby engage a receiving module 330 to create an appropriate record of that commodity within system 300. Further, new commodities may be brought into system 300 via receiving module 330. A receiving module 330 may comprise a facility that physically verifies the legitimacy, purity, and/or authenticity of a commodity, and may comprise a partner facility, such as a granary, a refinery, a depository or other type of commodity storage facility, etc. Receiving module 330 may include or interface with a product verification module 335. If product verification module 335 cannot verify the attributes of commodities received by receiving module 330, the commodities may be removed from the system by module 338 or dispatched to a processing facility 337 to allow those commodities to be processed to attain the desired attributes. In some instances, a commodity may require (or a commodity owner may desire) further processing of that commodity, such as may occur at a processing facility 337. Processing facility 337 may be, for example, a metal refiner, a grain mill, or other type of service that processes or otherwise modifies a commodity, either to change it to a different commodity or to purify the commodity. Whether subjected to further processing or not, a commodity within the system 300 may be directed to a storage facility 367, which may comprise any type of commodity storage service, such as a depository, that may retain a commodity within the system 300. Storage facility 367 may provide fractional storage of commodities, thereby permitting participants 310 to system 300 to own only a fraction of a commodity retained within storage 367.

Systems such as described in the example of FIG. 3 of a system 300 in accordance with the present invention may be used for transactions involving commodities such as precious metals, but similar systems may be used for the purchase, sale, or exchange of any other type of commodity, such as non-precious metals, grains, industrial resources or other inputs, power sources, etc. Some components, steps, and/or modules of the example depicted in FIG. 3 may be omitted without departing from the scope of the present invention. Further, additional steps, components, and/or modules may be added to systems in accordance with the present invention without departing from the present scope.

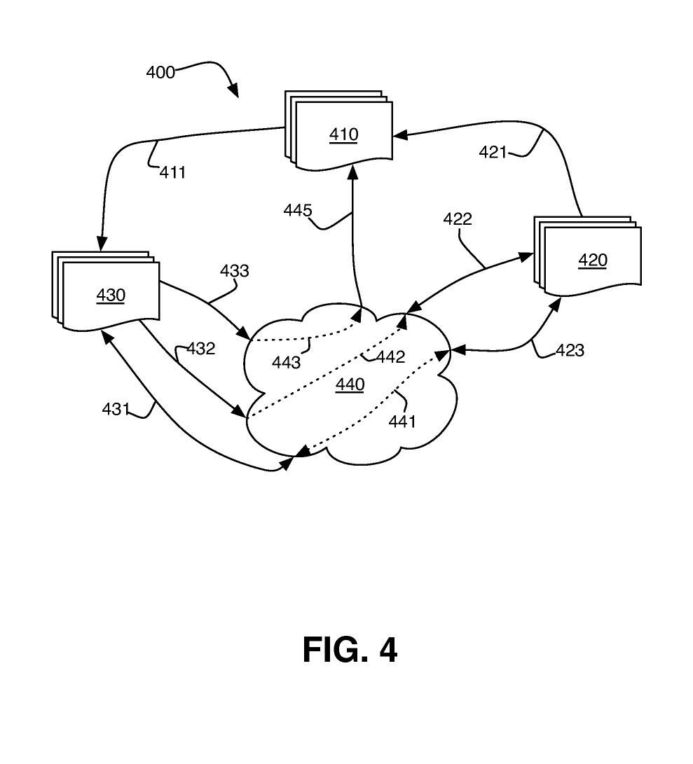

Referring now to FIG. 4, a further example of a system 400 in accordance with the present invention is illustrated. One or more exchange system 440, which may be operated by one or more metal exchange companies if the example system 400 is to be used for the exchange of commodity metals, may interface with a plurality of customers 430, a plurality of distribution centers 410, and a plurality of depositories 420 or other storage services. Customers 430 may take delivery 411 of a purchased commodity from a distribution center 410. A distribution center 410 may receive 421 a commodity for delivery from a depository 420, although in some examples a distribution center 410 and a depository 420 may be co-located or may comprise a single facility. A depository 420 may be insured as required by participants to system 400 or the owner/manager of system 400. The exchange system 440 may coordinate various transactions using computing systems such as servers, a distributed computing system, and other systems in accordance with the present invention as described herein to coordinate buy/sell/exchange orders 432 from customers 430, to coordinate 443 buy and ship requests 433 from customers 430, to coordinate deliveries 445 of commodities to distribution centers 410 to meet shipment or distribution needs, to coordinate 442 storage requirements and requests 422 with depositories 420, and to generally manage the geographical transfer and distribution of commodities within parameters such as the capacity of various depositories 410, requests of customers 430, to comply with regulatory requirements, for the efficient allocation of commodities, in anticipation of potential shipment requests or orders, or for other reasons. The exchange system 440 may exchange 423 information with depositories 420 and may further exchange 431 information with customers 430 to coordinate 441 geographic transfers of commodities. The exchange system 440 may optionally further provide various services, such as the processing of payments, bad actor prevention, access to a commodity network such as (in the case of metal commodities) a global physical bullion network, market maker functions, access to a secure storage network, and purity guarantees for the exchanged commodities. The exchange system 440, one or more depository 420, and/or one or more participant/customer 430 may operate as a market maker within system 400 to ensure the availability of buyers and/or sellers of commodities and to permit desired market operations.

While systems and methods in accordance with the present invention have been described in particular examples, these examples are used for explanatory purposes only. The present invention is not limited to any particular type of commodity, depository or distribution system, exchange medium, software type or system, computing device, network arrangement or protocol, or ultimate use or purpose of the commodities involved. Systems and methods in accordance with the present invention may be operated by and/or used by market makers to ensure that there will consistently be buyers and sellers for desired transactions. Any participant, which may optionally participate as market makers in systems and methods in accordance with the present invention, may be certified or verified in order to participate in a system in accordance with the present invention. Certification or verification may involve a provision of assurance as to the physical integrity or security of one or more facility, a level of insurance of a facility, an adequacy of a supply of commodities, or the validation of any other necessary factor.

1. A system for matching buyers and sellers of commodities and allocating commodities, the system comprising:
a plurality of commodity storage facilities, each of the plurality of the plurality of commodity storage facilities maintaining a supply of at least a first type of a commodity;
a record system that maintains records of the types and amounts of commodities maintained at each of the plurality of commodity storage facilities, the record system updatable to reflect the ownership of commodities and any commodities added to or removed from a commodity storage facility;
a buyer verification system that validates the identity and available resources of a potential purchaser of commodities;
a receiving module that verifies commodities entering into one or more of the plurality of commodity storage facilities;
a matching engine that receives preferences and requirements of a potential purchaser and identifies what records in the record system of commodities available for purchase matches the preferences and requirements of the potential purchaser; and
a payment module that transfers ownership of the identified commodities to the purchaser and transfers the resources paying for the purchaser to one or more seller of the commodities.

2. The system of claim 1, further comprising a delivery module that coordinates the delivering of purchased commodities to a buyer.

3. A method for managing the buying, selling, and exchanging of commodities, the method comprising:
verifying a supply of commodities available for purchase, the commodities available for purchase owned by at least one of a plurality of sellers;
receiving selling parameters required by each of the plurality of sellers of the commodities in the verified supply of commodities;
verifying potential buyers of commodities;
receiving purchasing parameters from at least one of the potential buyers of commodities;
matching the selling parameters and the purchasing parameters to identify a potential trade; and
executing the identified trade.

4. The method of claim 3, wherein the selling parameters and the purchasing parameters comprise at least a commodity type and a commodity price.

5. The method of claim 4, wherein the selling parameters and the purchasing parameters further comprise at least a commodity location and a commodity delivery or retention option.

6. The method of claim 3, wherein executing the identified trade comprises updating a record of commodity ownership from the seller to the purchaser of the commodity and transferring resources from the purchaser to the seller of the commodity.

7. The method of claim 6, wherein updating a record of commodity ownership comprises updating a record of fractional ownership of a larger unit of the commodity.

8. The method of claim 3, further comprising delivering the purchased commodities to a purchaser.

9. The method of claim 3, further comprising storing the purchased commodities in a commodity storage facility.

10. The method of claim 8, wherein storing the purchased commodities in a commodity storage facility further comprises storing the purchased commodities in commodity storage facilities having a geographical locations selected by the purchaser.
